(19) United States
(12) Patent Application Publication
(10) Pub. No.: US 2011/0154610 A1
(43) Pub. Date: Jun. 30, 2011

(54) Safety door stopper

(76) Inventor: Angel Sanz, Reisterstown, MD (US)

(21) Appl. No.: 12/928,553

(22) Filed: Dec. 15, 2010

Related U.S. Application Data
(60) Provisional application No. 61/290,344, filed on Dec. 28, 2009.

(51) Int. Cl. E05F 5/00

(52) U.S. Cl. 16/82

(57) ABSTRACT

A method and apparatus to prevent children or physically/mentally challenged adults from closing the door, while at the same time allowing the normal function of opening and closing the door by an authorized person. The device is installed on the upper portion of the door frame, out of reach of children, by means of a fastener like “Velcro” adhered to the back of the apparatus. In the normal mode it prevents the door form closing. To allow the door to close, a string is pulled while closing the door.

### BACKGROUND OF THE INVENTION

The present invention relates to a “Safety Door Stopper” for use at home, schools or other locations where children or physically/mentally challenged adults are present. Injuries are suffered when fingers or limbs get pinched between the door frame and the door. Children can lock themselves inside the room presenting a potential safety hazard.

The Safety Door Stopper prevents children or physically/mentally challenged adults from closing the door, while allowing the normal opening and closing of the door by an authorized person. The Child Safety Door Stopper is portable in nature allowing the quick installation and removal from the door frame.

### SUMMARY OF THE INVENTION

It is therefore a primary object of the present invention to provide a “Safety Door Stopper” composed of simple, inexpensive and light components for parents, guardians and supervisory personnel to protect children or physically/mentally challenged adults from injuries caused by unwanted door closings. The “Safety Door Stopper” provides a simple and attractive way to install and operate a device that can be carried by travelers as well as installed at home or institutions in a permanent or semi-permanent manner.

### BRIEF DESCRIPTION OF THE DRAWING FIGURES

FIG. 1 is a perspective view showing the “Safety Door Stopper” installed on a door frame preventing the door from closing

FIG. 2 is a perspective view showing the “Safety Door Stopper” installed on a door frame allowing the door to close

FIG. 3 is a perspective view of the “Blocker” with the “Pivot Hinge” fastened to it

FIG. 4 is an elevation view showing the blocker in the position of preventing or allowing the door to close

FIG. 5 is a side view showing t blocker in the retracted position

### DETAIL DESCRIPTION OF THE PREFERRED EMBODIMENT

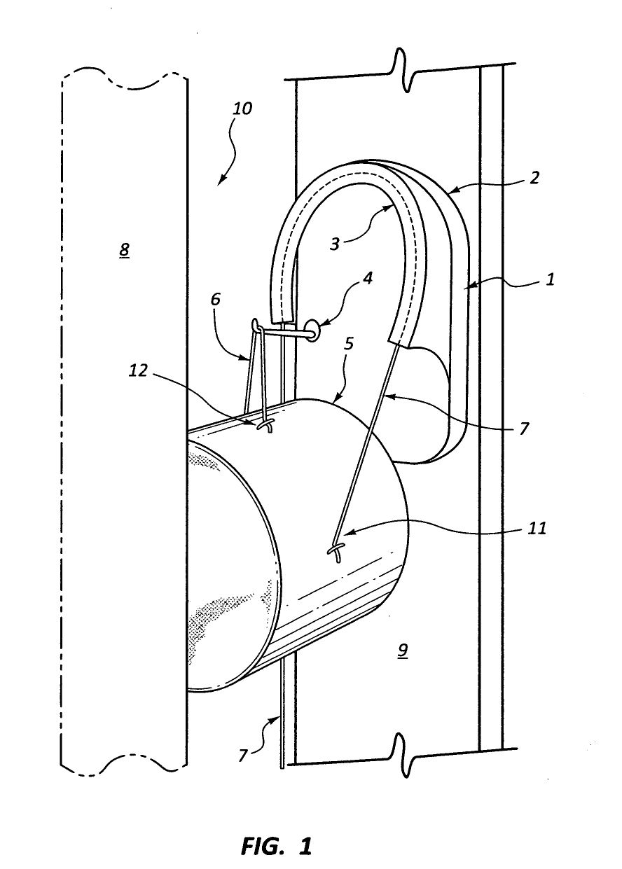

Please refer to FIGS. 1. The “Safety Door Stopper” of the present invention includes a housing 1 that provides a mounting surface for the string guide 3, the pivot 4 and the fastener velcro 2. A string 7 terminating in a suitable pull handle is threaded through the left opening of the cable guide 3 coming out of the right opening and fastened to the surface of a blocker 5 at 11. The blocker 5 is also hanging from the pivot 4 by a pivot hinge 6 fastened to the blocker at 12

The housing 1 is fastened to the door frame 9 by the velcro 2 in a way that is tangent to the edge of the door frame 9. In a normal position to prevent the door 8 from closing, the blocker 5 hanging from the pivot 4 by the pivot hinge 6 interferes with normal closing of the door. When the door 8 needs to be closed, the string 7 is pulled using the string handle until the blocker 5 stops against the exit of the string guide 3. This action retracts the blocker 5 from the edge of the door frame 9 allowing the normal closing of the door 8. The width of the blocker 5 determines the level of opening of the door.

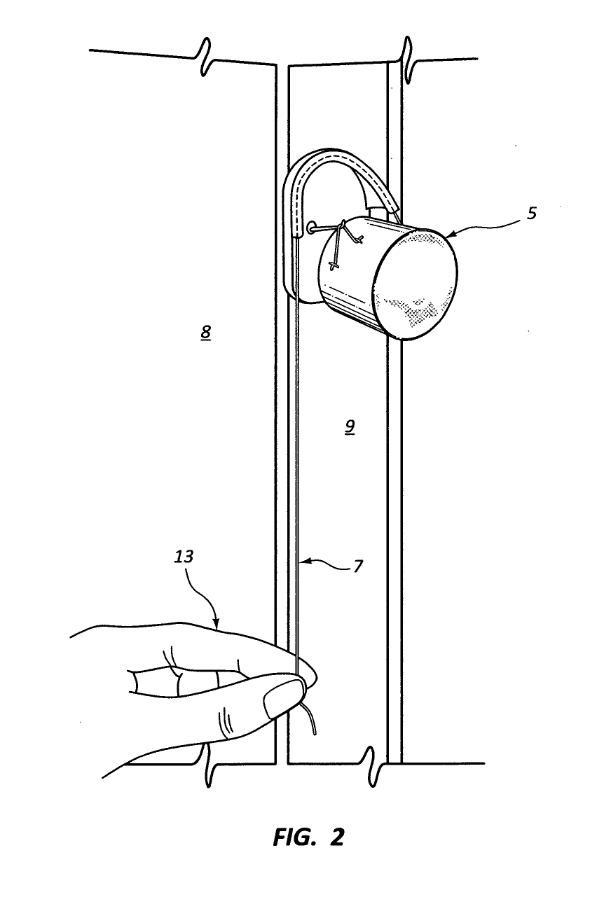

Please refer to FIG. 2. The Safety Door Stopper of the present invention is shown mounted on the door frame and an operator hand 13 is pulling the string 7 to retract the blocker 5 from the edge of the door frame 9, thus allowing the normal closing of the door 8.

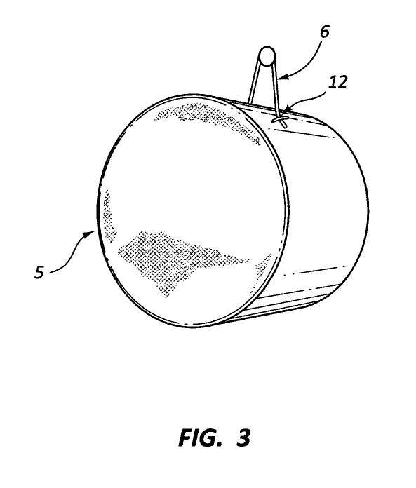

Please refer to FIG. 3. The blocker 5 is shown with the pivot hinge 6 attached to 12 in 2 places. The pivot hinge is made of steel tempered wire with a loop on the top or any other suitable material. The loop is hanging from the pivot 4 and allows two levels of freedom of motion. One is a coplanar rotation about the pivot 4 to allow the blocker 5 to be pulled by the string 7 out of the edge of the door frame 9 allowing the normal closing of the door 8. The other freedom of motion is a rotation about the vertical axis to allow the blocker 5 to move out of the door 8 when is closed and the blocker is hanging from the pivot 4.

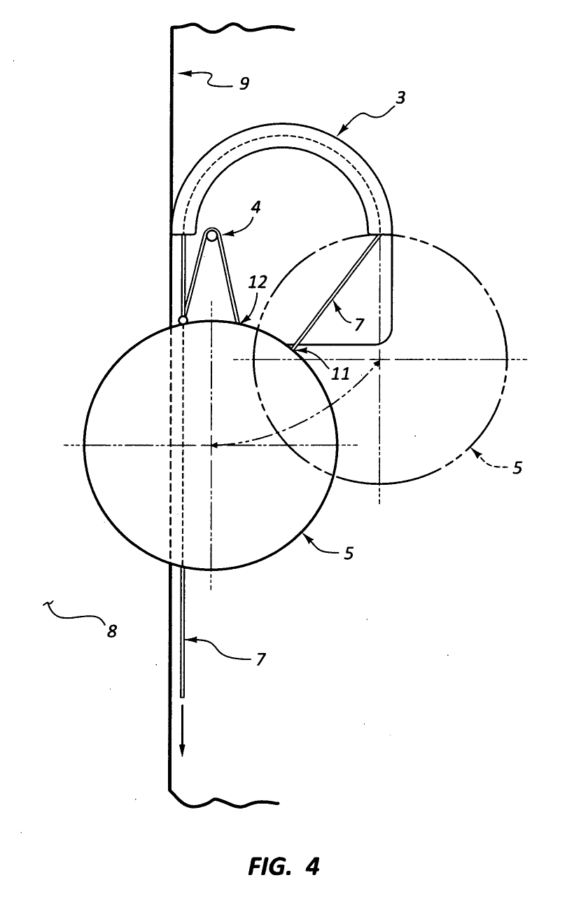

Please refer to FIG. 4. This elevation view shows the blocker 5 displayed in solid line, hanging from the pivot 4 by the pivot hinge 6 preventing the door from closing. It also shows the blocker displayed in dashed lines tight against the string guide 3 while the authorized person pulls at the string allowing the door to close

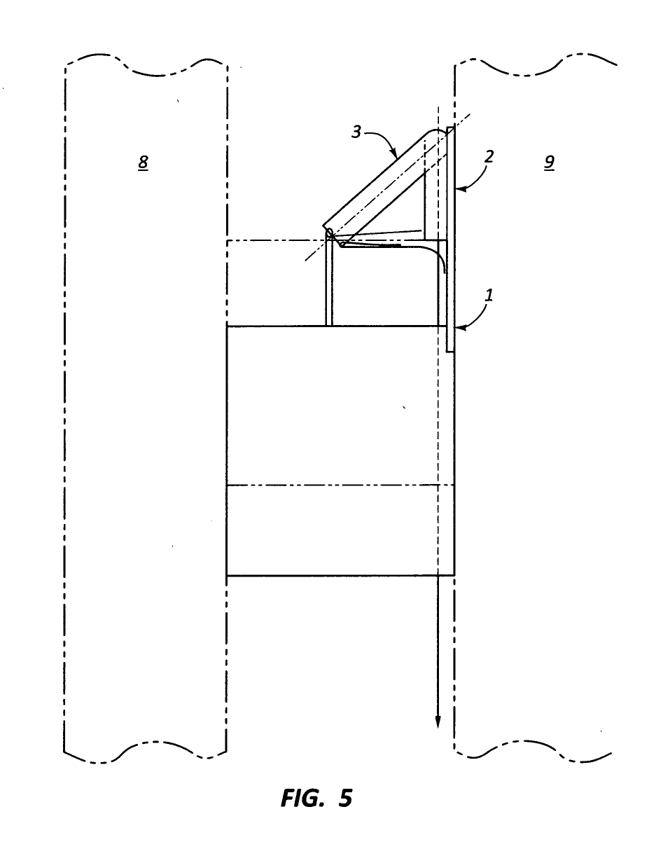

Please refer to FIG. 5. This side view shows the blocker displayed in dashed lines tight against the string guide 3 while the authorized person pulls at the string allowing the door to close.

1. A method and apparatus to prevent the closing of a door while at the same time allowing the normal function of opening and closing the door.

2. The method and apparatus of claim 1 wherein a housing integrally contains a string guide, sloped cam a pivot and a fastener attached to the back of the housing.

3. The method and apparatus of claim 1 with a fastener to be used to locate and hold the housing to the edge of a door frame.

4. The method and apparatus of claim 1 where the pivot is used to hang a door blocker by means of a pivot hinge.

5. method and apparatus of claim 1 where a string is threaded through the string guide to be attached to the blocker on one end of the string. The string is used to retract the blocker to allow normal door closing by pulling on the string.

6. method and apparatus of claim 1 where cylindrical blocker can be replaced with other suitable object such as a star or other geometrical shapes

7. method and apparatus of claim 1 where the housing, pivot and string guide, can be made of injection molded plastic material all in one piece or separate

8. method and apparatus of claim 1 where the blocker and the pivot hinge can be made of injection molded plastic material all in one piece or separate

9. method and apparatus of claim 1 where the string can be made of fishing nylon line or any other material such as propylene or steel either plain or multi-strand.

10. method and apparatus of claim 1 where the cable can be made to operate manually or automatic by remote control using a solenoid or other suitable automatic control. The selected control system would pull and release the string.

11. method and apparatus of claim 1 where the blocker in the form of a hockey puck and housing can be made with graphics to display hockey teams or other suitable and marketable displays.
